(19) United States
(12) Patent Application Publication
(10) Pub. No.: US 2023/0247136 A1
(43) Pub. Date: Aug. 3, 2023

(54) AUTOMATED ATTENDANT THAT SPECIFIES AUDIO TRANSMISSION CHARACTERISTICS FOR CALLS

(71) Applicant: Avaya Management L.P., Durham, NC (US)

(72) Inventors: Paul Roller Michaelis, Louisville, CO (US); Richard Alan Windhausen, Boulder, CO (US)

(21) Appl. No.: 17/691,984

(22) Filed: Mar. 10, 2022

Related U.S. Application Data
(60) Provisional application No. 63/305,796, filed on Feb. 2, 2022.

(51) Int. Cl. H04M 3/42; H04M 11/06; H04M 7/12

(52) U.S. Cl. CPC H04M 3/42391; H04M 11/066; H04M 7/1295; H04M 2203/253

(57) ABSTRACT

The technology disclosed herein enables automatic specification of audio transmission characteristics for calls between endpoints. In a particular embodiment, a method includes presenting a query to a user of a first endpoint about a type of call to be established with a second endpoint. The type of call is one of a plurality of call types that respectively correspond to different audio transmission characteristics. The method further includes configuring an audio transmission characteristic based on a response to the query and establishing a call between the first endpoint and the second endpoint using the audio transmission characteristic.

### RELATED APPLICATIONS

This application is related to and claims priority to U.S. Provisional Patent Application 63/305,796, titled “AUTOMATED ATTENDANT THAT SPECIFIES THE NETWORK TRANSMISSION CHARACTERISTICS,” filed Feb. 2, 2022, and which is hereby incorporated by reference in its entirety.

### TECHNICAL BACKGROUND

A TTY (Teletype) is a device used for text telecommunication by people who are deaf, hearing impaired, or speech impaired. Support for TTY communication is required by Section 508 of the Rehabilitation Act of 1973 and by the Federal Communications Commission (FCC). SIP (Session Initiation Protocol) systems had been exempt from this requirement, but that is no longer the case. Although TTY communication is very reliable on the PSTN (Public Switched Telephone Network), audio transmission techniques that are commonly used in SIP telecommunication systems—notably voice-optimized compression codecs and reliance on packet loss concealment algorithms—can cause TTY communication to fail. Providing TTY-compatible audio transmission characteristics for all calls (and not just for the TTY calls that need it) can add significantly to the cost of a SIP system.

### SUMMARY

The technology disclosed herein enables automatic specification of audio transmission characteristics for calls between endpoints. In a particular embodiment, a method includes presenting a query to a user of a first endpoint about a type of call to be established with a second endpoint. The type of call is one of a plurality of call types that respectively correspond to different audio transmission characteristics. The method further includes configuring an audio transmission characteristic based on a response to the query and establishing a call between the first endpoint and the second endpoint using the audio transmission characteristic.

In some examples, the method includes receiving the response in a first signaling type. The audio transmission characteristic corresponds to the first signaling type.

In some examples, the first signaling type includes a teletype (TTY) character and the query directs the user to select any key on a TTY device at the first endpoint to transmit the TTY character in response to the query. In those examples, the query may direct the user to select any Dual-Tone Multi-Frequency (DTMF) key to transmit a second signaling type comprising a DTMF signal.

In some examples, the response indicates that the type of call is teletype (TTY) and configuring the audio transmission characteristic includes selecting a TTY-compatible transmission characteristic. In those examples, the query may ask the user whether the type of call is TTY or voice and a voice-optimized transmission characteristic for a voice-type call may be different than the TTY-compatible transmission characteristic.

In some examples, establishing the call includes transmitting a session invite to the second endpoint that requests the call to have the audio transmission characteristic. In those examples, the session invite may be a Session Initiation Protocol (SIP) invite.

In some examples, the method includes exchanging user communications between the first endpoint and the second endpoint over the call.

In some examples, the method includes initiating establishment of the call to the first endpoint.

In another example, an apparatus is provided having one or more computer readable storage media and a processing system operatively coupled with the one or more computer readable storage media. Program instructions stored on the one or more computer readable storage media, when read and executed by the processing system, direct the apparatus to present a query to a user of a first endpoint about a type of call to be established with a second endpoint. The type of call is one of a plurality of call types that respectively correspond to different audio transmission characteristics. The program instructions further direct the apparatus to configure an audio transmission characteristic based on a response to the query and establish a call between the first endpoint and the second endpoint using the audio transmission characteristic.

### BRIEF DESCRIPTION OF THE DRAWINGS

FIG. 1 illustrates an implementation for automatically specifying audio transmission characteristics between endpoints.

FIG. 2 illustrates an operation to control access to automatically specify audio transmission characteristics between endpoints.

FIG. 3 illustrates an operational scenario for automatically specifying audio transmission characteristics between endpoints.

FIG. 4 illustrates an implementation for automatically specifying audio transmission characteristics between endpoints.

FIG. 5 illustrates an operational scenario for automatically specifying audio transmission characteristics between endpoints.

FIG. 6 illustrates an operational scenario for automatically specifying audio transmission characteristics between endpoints.

FIG. 7 illustrates an operational scenario for automatically specifying audio transmission characteristics between endpoints.

FIG. 8 illustrates a computing architecture for automatically specifying audio transmission characteristics between endpoints.

### DETAILED DESCRIPTION

Unlike fax machines and computer modems, which also transmit communications over audio calls, TTY devices have no “handshake” procedure at the start of a call, nor do they have a carrier tone during the call. Although this approach tends to limit the speed of transmission, it has the advantage of permitting TTY tones, DTMF, and voice to be intermixed on the same call. Since there is no handshake, TTY characters are each transmitted in a sequence of seven individual tones in accordance with the TTY standard. A start tone at 1800 Hz is followed by a series of five tones at either 1400 or 1800 Hz that specify the character. A stop tone at 1400 Hz then signifies the last tone in the seven-tone sequence. The first six tones are specified to be 22 milliseconds long while the seventh, stop tone, can be anywhere from 22 to 44 milliseconds in duration. The operation is half duplex, so TTY users must take turns transmitting or their TTY tones will overlap and result in no-text, or garbled text, being displayed at the endpoints. There is no automatic mechanism that lets users know whether the character they sent is actually received properly at the other end of the call.

Given the characteristics of TTY communications described above, characteristics of audio calls carried over communication networks other than the Public Switched Telephone Network (PSTN), such as a packet network using the Session Initiation Protocol (SIP), may result in poor TTY communication performance. For instance, if TTY signaling (i.e., tones) are encoded and transported using a voice-optimized “compression codec,” such as G.729, the signals are often so badly distorted that they cannot be reliably decoded by the receiving device. Another audio codec commonly available as an option in SIP systems, G.711, is able to transmit voice and TTY communication reliably. A reason it is often not economically feasible to use G.711 for all calls, both voice and TTY, is that it requires considerably more network bandwidth than G.729 (approximately 64 Kbit/S as compared with 8 Kbit/S for standard G.729). Even when G.711 encoding is used, packet loss—even at levels that would not be noticeable in a voice call—can corrupt the TTY signals. For example, with 20 ms G.711 audio packets, a packet loss rate of only 0.12% would cause the TTY character error rate to exceed the FCC's allowable limit. Even in a system that has enough bandwidth to support G.711 for all calls, it might still be necessary to adjust the QoS (Quality of Service) parameters for TTY calls, enable RFC2198-style redundant transmission of packets, adjust the echo cancellation parameters, or perhaps even use TCP/IP instead of UDP.

The technology described below distinguishes between voice calls and TTY calls, thereby allowing calls to be configured with a higher bandwidth codec (e.g., G.711) and near-zero packet loss only when that level of service is required. Since, unlike fax machines and computer modems, TTYs have no “handshake” procedure at the start of a call, the technology includes an alternative way to distinguish between voice calls and TTY calls that are routed to the same endpoint. The call established with the endpoint would still be an audio call regardless but the transmission characteristics of the call (e.g., codec used or acceptable packet loss rate) would differ between a call intended for voice and a call intended for signaling like that used for TTY. The differing characteristics are, therefore, not intended to improve the experience of users on a voice call but, rather, are needed for reliable TTY signaling transmission.

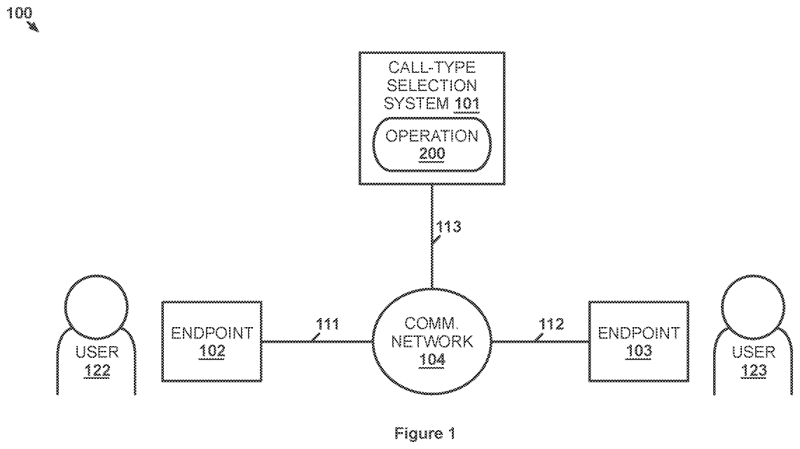

FIG. 1 illustrates implementation 100 for automatically specifying audio transmission characteristics between endpoints. Implementation 100 includes call-type selection system 101, endpoint 102, endpoint 103 and communication network 104. Users 122-123 operate endpoints 102-103, respectively. Communication network 104 includes one or more local area networks and/or wide area networks, such as the Internet and/or the PSTN, over which systems 101-103 communicate. Call-type selection system 101 and communication network 104 communicate over communication link 113. Endpoint 102 and communication network 104 communicate over communication link 111. Endpoint 103 and communication network 104 communicate over communication link 112. Communication links 111-114 are shown as direct links but may include intervening systems, networks, and/or devices.

In operation, endpoints 102-103 may each respectively be a telephone, TTY device, tablet computer, laptop computer, desktop computer, conference room system, or some other type of communication device capable of connecting as endpoints to audio calls including combinations thereof. Call-type selection system 101 is an intermediate system in a signaling path between endpoint 102 and endpoint 103. Call-type selection system 101 may simply facilitate the setup of a direct call between endpoint 102 and endpoint 103 or call-type selection system 101 may remain in the call path for audio user communications exchanged between endpoint 102 and endpoint 103. In some examples, call-type selection system 101 may bridge a call between two different types of networks (e.g., between the PSTN and a packet network). Call-type selection system 101 may operate as a bridge only in situations where bridging is necessary while also being able to handle calls between endpoints on the same type of network (e.g., both endpoints communicating over a packet-based voice network). In some examples, call-type selection system 101 may be a system involved in the routing of calls within a contact center. Call-type selection system 101 performs operation 200 to automatically determine audio transmission characteristics for a call (e.g., TTY or voice) based on a response received from user 122.

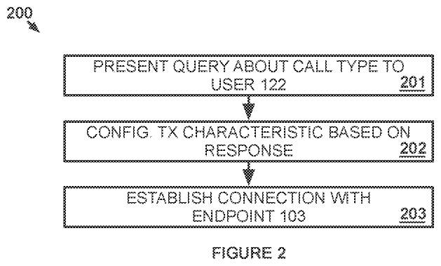

FIG. 2 illustrates operation 200 to control access to automatically specify audio transmission characteristics between endpoints. During operation 200, call-type selection system 101 present a query to user 122 of endpoint 102 about a type of call to be established with endpoint 103 (201). The type of call is one of multiple possible call types that respectively correspond to different audio transmission characteristics. The multiple possible call types focused on herein are traditional TTY calls and traditional voice calls. Although, other types of calls that use an audio channel may similarly benefit from call-type selection system 101 automatically determining the call type. For instance, another protocol may be used by endpoint 102 to send information encoded in signals transmitted in audible frequencies. Other, more modern forms of TTY calling may also be used, such as Turbo Code™. The query may be presented by call-type selection system 101 transferring an audio message over a call connection established with endpoint 102. The query may ask user 122 to indicate which call type they intend to participate in when connected to endpoint 103. For example, the query may be a pre-recorded audio message from another user, or a synthesized voice message, that speaks to user 122 asking them for a call type selection. The query may provide user 122 with one or more mechanisms for responding, such as speaking a response into endpoint 102 for transmission over the audio call connection with call-type selection system 101 (e.g., using Interactive Voice Response (IVR) capabilities of call-type selection system 101), dialing a button on a dial pad of endpoint 102 to send a DTMF signal over the audio call connection, typing one or more keys of a TTY device associated with endpoint 102, or some other mechanism enabling a user to respond over an audio call connection—including combinations thereof (e.g., “Dial 1 for voice or say ‘voice’ into your phone”). Since TTY users are most likely unable to hear any speech in an audio-based query, the query may include a TTY message (e.g., following the spoken message) indicating a response for requesting TTY. For instance, the audio of the query may first present the speech “Dial 1 for voice” and then include TTY character tones that result in “Dial 2 for TTY” being displayed by user 122's TTY device. If user 122 can hear, user 122 will hear the speech followed by unintelligible tones carrying the TTY characters while, if user 122 is using a TTY device, the TTY device will display the TTY message and user 122 may not even know about the first, spoken part of the query. In some cases, the speech portion may also speak the “Dial 2 for TTY” message just in case user 122 can hear the message but would still prefer to use TTY. In some examples, multiple responses may correspond to the same type of call. For instance, the message may indicate “Dial 1 for English, Dial 2 for Spanish, Dial 3 for TTY English, and Dial 4 for TTY Spanish.” Of course, in accordance with the above example, the last two options in that example may also, or instead, be sent as TTY characters. Regardless, the query in the example includes two options for a voice call and two options for a TTY call but there are only two call types as far as call-type selection system 101 is concerned, TTY and voice. In some examples, the type of signaling received in the response may be enough to signify to call-type selection system 101 the call type. For example, receiving a TTY communication from endpoint 102 may indicate that user 122 wishes to establish a TTY call regardless of what characters were sent in the TTY signal. Requiring receipt of a TTY communication from endpoint 102 has the added advantage of preventing a voice user without a TTY device from selecting a TTY-type call because a TTY-type call may have one or more audio transmission characteristics that improve the voice call experience even though they are not necessary for the voice-type call.

As noted above, the query is transmitted over an audio call connection with endpoint 102. That audio call connection may be a PSTN connection or may be a connection established using a packet-based call protocol, such as SIP. The call may have been initiated from endpoint 102 or from call-type selection system 101. In an example of the former, user 122 may direct endpoint 102 to call endpoint 103 (e.g., may dial a phone number associated with endpoint 103). The call may be directed to endpoint 103 specifically or to a group of potential endpoints that included endpoint 103 (e.g., user 122 may be calling a contact center to speak with an agent and the call is routed to endpoint 103 over one of the other endpoints of the contact center). In an example where call-type selection system 101 calls endpoint 102, call-type selection system 101 may be part of a contact center that reaches out to customers and then connects them to an endpoint in the contact center after receiving a response to the query. In another example, call-type selection system 101 may be an emergency alert system, sometimes referred to as a reverse-911 system. Call-type selection system 101 may dial endpoint 102 along with other endpoints in a geographic area designated for receiving the alert. After endpoint 102 answers the query from call-type selection system 101, endpoint 103 is connected to endpoint 102 to play an emergency alert message or send TTY signaling with the message, to user 122 depending on user 122's response to the query. In that example, endpoint 103 may be a system that does not require active engagement from user 123 (i.e., may be an automated system).

Call-type selection system 101 configures an audio transmission characteristic based on a response to the query (202). The audio transmission characteristic is any characteristic that affects how audio will be exchanged over the call with endpoint 103. For example, the audio transmission characteristic may be a particular audio codec, a setting for the codec, a packet loss parameter (e.g., a maximum amount of packet loss that is acceptable for the call type), a jitter parameter, a latency parameter, echo cancelation parameters, a parameter indicating the number of times duplicate packets are transmitted to compensate for packet loss, or any other type of parameter defining how audio should be encoded and transmitted in packets including combinations thereof. While only one audio transmission characteristic is discussed herein, the audio transmission characteristic may be one of multiple audio transmission characteristics that are configured by call-type selection system 101 depending on the type of call defined in the response to the query. If call-type selection system 101 is to remain in the audio signal path for the call (e.g., to bridge a call connection between call-type selection system 101 and endpoint 102 to a call connection between call-type selection system 101 and endpoint 103), then the audio transmission characteristic may only be applied to the call connection between call-type selection system 101 and endpoint 103. For example, endpoint 102 may connect over the PSTN to call-type selection system 101 and the audio transmission characteristic may not apply to PSTN connections. A packet-based connection to endpoint 103 may then be established to have the audio transmission characteristic. If endpoint 102 is using a packet connection rather than the PSTN, then the audio transmission characteristic may apply to the end-to-end connection between endpoint 102 and endpoint 103 regardless of whether call-type selection system 101 is in the call path. In some examples, the audio transmission characteristic for each call type may be implemented on a communication path to endpoint 103. In those examples, configuring the audio transmission characteristic may simply involve selecting the path having the desired characteristic.

After configuring the audio transmission characteristic for the call, call-type selection system 101 establishes the call between the first endpoint and the second endpoint using the audio transmission characteristic (203). If call-type selection system 101 is bridging call communications between a connection with endpoint 102 and a connection to be established with endpoint 103, then call-type selection system 101 may establish the call by transmitting a session invite request to endpoint 103. The session invite request, or subsequent messaging from call-type selection system 101 to endpoint 103, may define the audio transmission characteristic to endpoint 103 so that both call-type selection system 101 and endpoint 103 can both transmit audio communications in accordance with the audio transmission characteristic. In another example, call-type selection system 101 may instruct endpoint 102 or endpoint 103 to transmit a session invite request to the other to establish the call without call-type selection system 101 in the audio transmission path. Like call-type selection system 101 in the example above, the audio transmission characteristic may be indicated in the call request or may be indicated in a subsequent message exchange. In some examples, establishing the call using the audio transmission characteristic may require reestablishing a call connection between call-type selection system 101 and endpoint 102. For instance, the call connection between endpoint 102 and call-type selection system 101 may be configured initially with a codec that requires more bandwidth (e.g., more Kbit/S) than is necessary for the type of call selected in response to the query. Call-type selection system 101 may then re-invite endpoint 102 to establish a call connection using a lower bandwidth codec that supports the selected type of call.

Advantageously, by querying user 122 prior to connecting endpoint 102 and endpoint 103, call-type selection system 101 can ensure that the audio transmission characteristic used for the call (at least for the leg between call-type selection system 101 and endpoint 103) are compatible with the call's type. For example, a voice call can use a less bandwidth intensive audio transmission characteristic while a TTY call can use a higher bandwidth audio transmission characteristic that is compatible with TTY communication (e.g., is capable of reliably carrying TTY tones). Regardless of the call type chosen by user 122, an audio call is established between the same two endpoints, the only difference being the mechanism utilized for transmitting the audio communication between those endpoints. Tailoring the audio transmission characteristic(s) used for the signaling being transmitted allows call-type selection system 101 to balance the amount of resources (e.g., bandwidth) being used for the call and requirements for reliably transmitting the signaling.

In some examples, rather than there being a separate call-type selection system 101, endpoint 103 may itself perform operation 200 in situations where endpoint 102 and endpoint 103 are in communication using a packet-based communication protocol (e.g., can exchange SIP messages to facilitate calls). If endpoint 102 calls endpoint 103 (or possibly endpoint 103 calls endpoint 102), then endpoint 103 may present the call-type query, receive a response, and configure the audio transmission characteristic based on the response. If the audio transmission characteristic configuration does not match the initial call connection (i.e., the call connection over which the query was transmitted), then endpoint 103 may send out a new call invite that indicates that the determined audio transmission characteristic should be used when reestablishing the call connection. For example, the initial call connection may have an audio transmission characteristic that is suitable for transmitting TTY characters but user 122 may indicate in their response to the query that TTY will not be used (e.g., user 122 wishes to speak). Endpoint 103 may then determine that an audio transmission characteristic that uses less resources than the TTY suitable audio transmission characteristic should be used to save resources. The call connection is then reestablished accordingly.

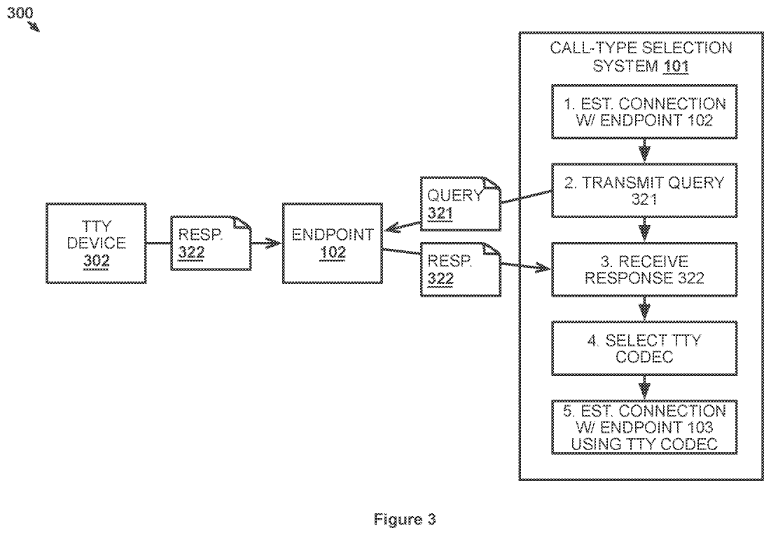

FIG. 3 illustrates operational scenario 300 for automatically specifying audio transmission characteristics between endpoints. Operational scenario 300 is an example of how call-type selection system 101 may perform when user 122 is a user of TTY device 302. TTY device 302 includes user interfaces into which user 122 inputs characters for transmission, such as a keyboard, and from which received TTY characters are presented to user 122, such as a display. TTY device 302 further includes processing circuitry necessary to produce TTY signal tones for transmission and interpret received TTY signal tones for display. In some examples, to exchange TTY signaling using endpoint 102, TTY device 302 may include an acoustic coupler that includes a cradle with a speaker and a microphone positioned such that a microphone from a handset from endpoint 102 aligns with the speaker of TTY device 302 and a speaker from the handset aligns with the microphone of TTY device 302. Other examples may include a different type of connection to endpoint 102 (e.g., TTY device 302 may plug into a port for a handset of endpoint 102). In this example, TTY device 302 is shown separately from endpoint 102 but, in some examples, TTY device 302 and endpoint 102 may be combined (i.e., the endpoint is the TTY device).

In operational scenario 300, call-type selection system 101 establishes a call connection at step 1 with endpoint 102. The call connection may have been initiated by endpoint 102 or by call-type selection system 101. After the connection is established, call audio can be transmitted over the call connection. In the case, call-type selection system 101 transmits query 321 in the call audio at step 2. Endpoint 102 presents the query 321 just as it would during a normal call between users. Query 321 includes audio that, as playback by endpoint 102 proceeds, first outputs speech (e.g., asking “Press 1 for voice”) followed by tones representing TTY characters, which may simply be ignored by a hearing user who is unaware that the tones represent characters. In this case, since TTY device 302 is being used, TTY device 302 does not recognize the speech in query 321 asking whether user 122 wants to establish a voice call (i.e., because the speech is not TTY tones that TTY device 302 can decode into characters). However, since query 321 also includes TTY tones, TTY device 302 recognizes those tones when playback of query 321 begins presenting the tones and decodes to present the characters therein to user 122. The characters spell out a message to user 122 defining how user 122 should respond to request a TTY-type call. For example, the message may indicate that user 122 should press any key on TTY device 302, may indicate that user 122 should press a specific key or key combination, may indicate that user 122 should dial a particular digit or symbol (typically numbers 0-9 and symbols * and #) on a dial pad of TTY device 302 or endpoint 102, or may indicate that user 122 should provide their selection in some other manner.

Since user 122 is using TTY device 302 in this example, user 122 indicates their desire to participate in a TTY-type call rather than a voice-type call, which causes TTY device 302 to generate response 322. Response 322 is passed to endpoint 102 which transmits response 322 in the audio of the call connection with call-type selection system 101. Upon receiving response 322 at step 3, call-type selection system 101 parses the response 322 to determine that user 122 has responded in accordance with query 321's instructions to indicate that user 122 desires a TTY-call. Accordingly, call-type selection system 101 selects a codec (i.e., audio transmission characteristic) for the call's audio at step 4 to be a codec that is compatible with TTY communication to ensure the TTY tones are transmitted reliably (e.g., no tones go unrecognized due to distortion caused by a low bit rate codec). After selecting the TTY-compatible codec, call-type selection system 101 establishes a connection with endpoint 103 at step 5 using the codec. Presumably, the call connection between call-type selection system 101 and endpoint 102 is already configured for TTY communication (e.g., is a PSTN connection or a packet-based connection using a TTY compatible protocol) since call-type selection system 101 expects the possibility that a response, such as response 322, may be received as a TTY communication from endpoint 102. However, if that is not the case, then call-type selection system 101 may reestablish the call connection with endpoint 102 as well using the selected codec to ensure TTY-signaling moving forward is exchanged reliably.

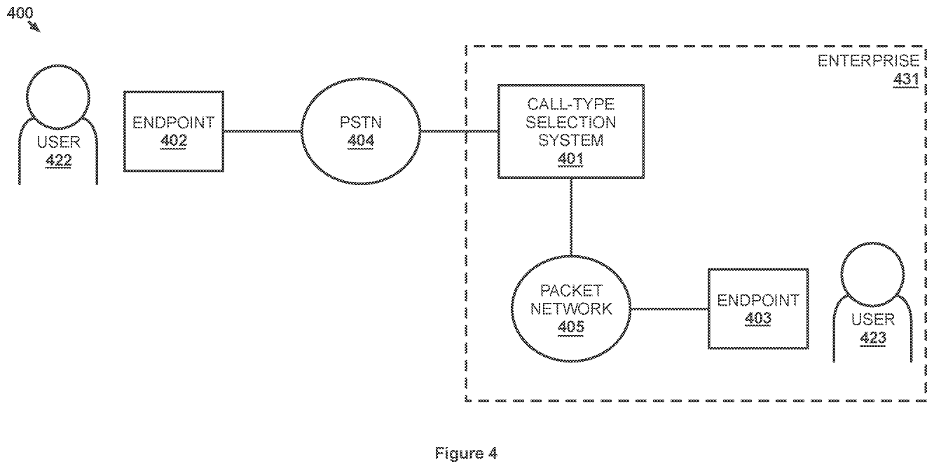

FIG. 4 illustrates implementation 400 for automatically specifying audio transmission characteristics between endpoints. Implementation 400 includes call-type selection system 401, endpoint 402, endpoint 403, PSTN 404, and packet network 405. Although, call-type selection system 401, endpoint 403 and packet network 405 are part of enterprise 431, no element of enterprise 431 needs be co-located with another. As such, packet network 405 may use the Internet to exchange communications. While only one endpoint is shown in enterprise 431, enterprise 431 may include any number of endpoints and users operating those endpoints. For example, enterprise 431 may be a business and packet network 405 may be used by enterprise 431 to connect endpoints of the business' employees.

In operation, enterprise 431 wants to limit the amount of resources used for call communications exchanged over packet network 405. Call-type selection system 401 is, therefore, employed to determine which calls require more resource intensive audio transmission characteristics necessary for TTY communication. This allows TTY-type calls to use the more resource intensive audio transmission characteristics while the remainder of the calls with, or within, enterprise 431 (i.e., voice-signaling calls in this example) can use less resource intensive audio transmission characteristics. In this example, call-type selection system 401 acts as a gateway between PSTN 404 and packet network 405. In other examples, call-type selection system 401 may be located within packet network 405 and a separate gateway system may be employed to transcode a call between PSTN 404 and packet network 405. In those examples, call-type selection system 401 may instruct the gateway about what audio transmission characteristic(s) should be used rather than implementing the characteristics itself, as in the examples below. Likewise, call-type selection system 401 would instruct any other system affecting audio transmission characteristic(s) to use the determined audio transmission characteristics for the identified call type. For example, if a connection cannot be established with endpoint 403 (e.g., user 423 is not there to answer), then call-type selection system 401 ensures a connection to a voicemail system uses the determined audio transmission characteristic(s).

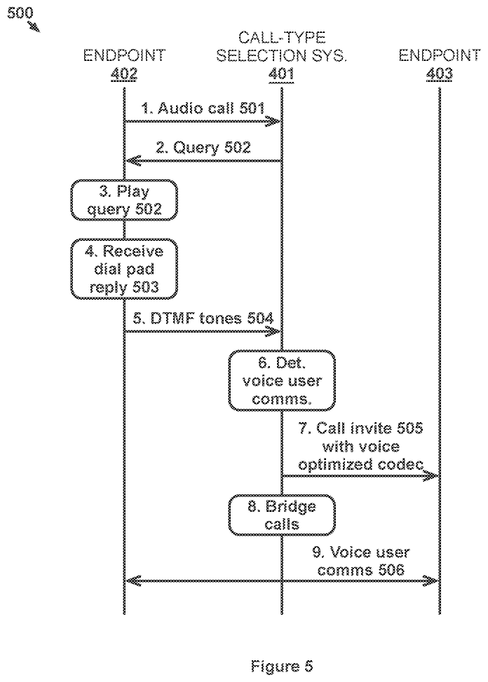

FIG. 5 illustrates operational scenario 500 for automatically specifying audio transmission characteristics between endpoints. Operational scenario 500 is an example where user 422 intends to speak with user 423 at enterprise 431 rather than use TTY. In operational scenario 500, endpoint 402 dials a phone number of endpoint 403 to initiate audio call 501 at step 1 over PSTN 404. Audio call 501 is an audio call that is typically used for voice communications over PSTN 404. Often such a call is simply referred to as a voice call but that terminology is avoided herein to avoid confusion when the call is carrying TTY characters instead. Thus, audio call 501 is capable of carrying other types of signaling, such as TTY characters or fax modem signaling, over its audio channel as well. Audio call 501 is connected to call-type selection system 401 upon being received at enterprise 431. That is, since call-type selection system 401 is a gateway between PSTN 404 and packet network 405 in this example, all calls routed to endpoints attached to packet network 405 are routed through call-type selection system 401. Endpoint 402 and call-type selection system 401 are, therefore, endpoints of audio call 501 at this point. Call-type selection system 401 transmits query 502 over audio call 501 and endpoint 402 receives and plays query 502 to user 422 in real time at step 3 (as is typically the case for audio signals transmitted to an endpoint over a PSTN call). In this example, query 502 is a message including speech that says, “Dial any key on the dial pad of your phone if you desire a voice call.” After that speech in query 502, query 502 includes TTY characters that spell out a message “Press any key on your TTY device if you desire a TTY call.” The tones are still played to user 422, although, user 422 may simply ignore them as unintelligible noise. In this example, user 422 presses a button on a dial pad of endpoint 402 receives their dial pad reply 503 at step 4. Dial pad reply 503 is transmitted in real-time as DTMF signaling 504 at step 5 over audio call 501. In this example, call-type selection system does not consider which specific character user 422 presses on the dial pad in dial pad reply 503, as call-type selection system 401 is merely concerned whether a signal carrying TTY tones is received over audio call 501 or a signal carrying DTMF tones is received over audio call 501 (or, in some cases, whether a signal of any type other than TTY tones is received over audio call 501). In other examples, call-type selection system 401 may be monitoring for a specific TTY character or a specific DTMF tone to represent user 422's selection.

Upon receiving DTMF signaling 504, call-type selection system 401 determines that user 422 wants to exchange voice user communications with user 423 (i.e., user 422 wants to speak with user 423 rather than use TTY). As such, call-type selection system 401 determines that a call connection with endpoint 403 should use a voice optimized codec, which, in this case, is a codec that uses less resources than a codec optimized for TTY. Call-type selection system 401 then transmits call invite 505, which may be a SIP invite or an invite in some other packet-based protocol used between call-type selection system 401 and endpoint 103 to establish a voice call connection over packet network 405, to endpoint 403 at step 7. Call invite 505 specifies that the voice optimized codec should be used for the new call connection. Call-type selection system 401 bridges, migrates, or otherwise connects audio call 501 at step 8 to the newly established call with endpoint 403. Voice user communications 506 are exchanged between endpoint 402 and endpoint 403 at step 9 over the bridged calls. Voice user communications 506 include user 422 and user 423's voices captured and transmitted in real-time so user 422 and user 423 can carry on a conversation.

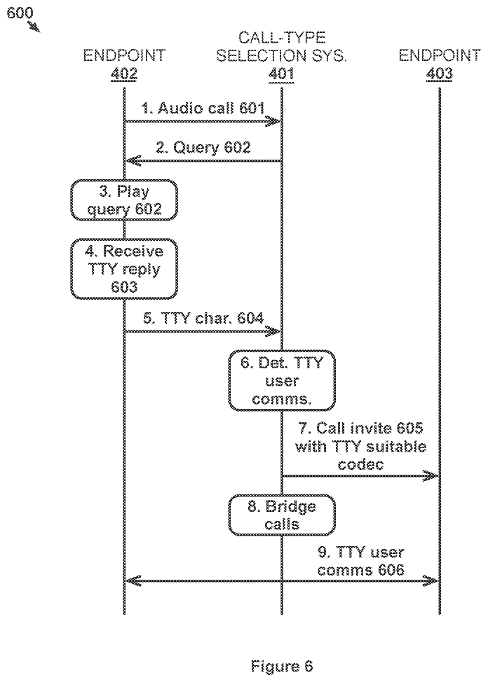

FIG. 6 illustrates operational scenario 600 for automatically specifying audio transmission characteristics between endpoints. Operational scenario 600 is an example where user 422 intends to use TTY on a call. In this example, endpoint 402 is a TTY-only device (i.e., no ability to send or receive voice), connected directly to PSTN 404 (e.g., via a residential standard RJ-11 hookup) and operated by user 422 solely for TTY communication. In operational scenario 600, despite user 422 intending to communicate using TTY, endpoint 402 dials the phone number of enterprise 431 to initiate audio call 601 at step 1 over PSTN 404. Since TTY signaling can be transmitted over a PSTN call, audio call 601 is no different than audio call 501 despite one being intended for voice and the other being intended for TTY. Query 602 is the same as query 502 and is similarly transmitted over audio call 601 at step 2 for playback by endpoint 402 at step 2. In this case, the speech portion of query 602 is ignored by endpoint 402 because endpoint 402 is looking for TTY communications (i.e., tones) in the audio received over audio call 601. Once the TTY communications of query 602 reaches endpoint 402, endpoint 402 displays the received TTY characters to reveal the TTY portion of the message in query 602 (i.e., “Press any key on your TTY device if you desire a TTY call”).

Since user 422 does want to use TTY for the call in this example, user 422 presses one of the keys (e.g., the key for the letter ‘h’) on endpoint 402. That key press constitutes TTY reply 603 being received by endpoint 402 at step 4. In response to the key being pressed, endpoint 402 produces tones representing the keyed in character as TTY character 604, which is TTY tones corresponding to the keyed in character, that is transmitted over audio call 601 at step 5 to call-type selection system 401. Upon receiving TTY character 604, call-type selection system 401 recognizes that TTY character 604 represents a TTY character having been entered at endpoint 402. Call-type selection system 401, therefore, determines that user 422 wishes to participate in a TTY communication with user 423 at step 6. The exact character of TTY character 604 does not matter for the purposes of the determination but, rather, simply that call-type selection system 401 received a TTY character at all. Once call-type selection system 401 determines that the call will carry TTY communications, call-type selection system 401 transmits call invite 605 at step 7 to endpoint 403, which triggers the establishment of a call over packet network 405 between call-type selection system 401 and endpoint 403. Call invite 605 specifies that a TTY optimized codec should be used for the new call connection, in contrast to the voice-optimized codec used in operational scenario 500. Call-type selection system 401 bridges, migrates, or otherwise connects audio call 601 at step 8 to the newly established call with endpoint 403. TTY user communications 606 are exchanged between endpoint 402 and endpoint 403 at step 9 over the bridged calls. TTY user communications 606 include TTY characters typed into endpoint 402 and endpoint 403 by their respective users 422 and 423. Each character is transmitted in real time using TTY communication tones over audio call 601.

Based on the examples of operational scenario 500 and operational scenario 600, endpoint 403 may be an endpoint that is capable of communicating both voice and TTY communications over calls established therewith. When a call comes in from endpoint 402, call-type selection system 401 is going to route the call to endpoint 403 regardless of the call-type selected in response to the query. Only the audio transmission characteristics (e.g., codec) for the call connection between call-type selection system 401 and endpoint 403 changes depending on the call-type. That call connection is still technically a voice connection regardless of the call-type. Even voice communications can be exchanged using the TTY suitable codec, but the TTY suitable codec uses more resources than the voice optimized codec to ensure TTY characters are transmitted reliably. The TTY suitable codec is not used for better QoS for voice calls even though that may be the case because enterprise 431 would rather (or is required to) limit resources used for calls when possible. Also, while the above examples only change the codec used (e.g., G.711 vs. G.729), other audio transmission characteristics may be changed as well. For example, the TTY suitable codec may be accompanied by a tolerable amount of packet loss that is lower than with the voice optimized codec because packet loss is more likely to affect TTY communications than voice communications.

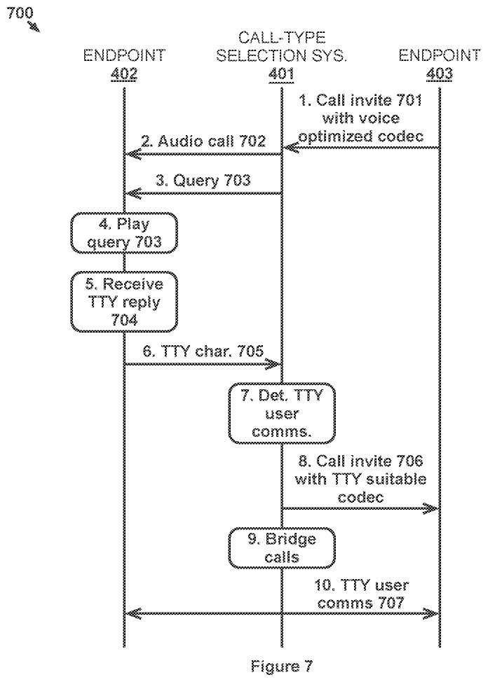

FIG. 7 illustrates operational scenario 700 for automatically specifying audio transmission characteristics between endpoints. Operational scenario 700 is an example where a call is dialed to endpoint 402 in contrast to the calls dialed from endpoint 402 in the above scenarios. In operational scenario 700, endpoint 403 transmits call invite 701 at step 1 to call-type selection system 401. Call invite 701 indicates that the voice optimized coded is to be used for the call connection established between call-type selection system 401 and endpoint 403 in response to call invite 701. In other examples, rather than call invite 701 having to indicate which codec should be used, calls may default to the voice optimized codec due to it requiring fewer resources. In response to call invite 701, call-type selection system 401 dials audio call 702 to endpoint 402 at step 2 over PSTN 404.

Assuming user 422 answers audio call 702, steps 3-7 proceed in a manner similar to steps 2-6 of operational scenario 600 because user 422 wishes to participate in a TTY call. Specifically, call-type selection system 401 transmits query 703, which is the same as queries 502 and 602, at step 3 over audio call 702 and endpoint 402 plays query 703 at step 4 to user 422, which results in user 422 reading the TTY portion of query 703 on endpoint 402. Endpoint 402 receives TTY reply 704 at step 5 and transfers TTY reply 704 in TTY character 705 to call-type selection system 401 at step 6 over call audio call 702. Call-type selection system 401 recognizes at step 7 that TTY character 705 (or any other TTY character tones in other examples) indicates that the TTY suitable codec should be used for the call connection with endpoint 403. Since the packet-based call connection between call-type selection system 401 and endpoint 403 was set up using the voice optimized codec, call-type selection system 401 transmits call invite 706 to endpoint 403 at step 8. Call invite 706 triggers the reestablishment of the call connection with endpoint 403 using the TTY suitable codec in place of the voice optimized codec. Once that new call connection is established, call-type selection system 401 bridges, migrates, or otherwise connects the new call connection to audio call 702 at step 9 so TTY user communications 707 can be exchanged between endpoint 402 and endpoint 403 at step 10.

As an example of operational scenario 700 occurring in practice, if a 9-1-1 emergency response center's (e.g., enterprise 431) records indicate the people associated with a specific phone number (i.e., Endpoint 402) include deaf TTY users and non-impaired individuals who communicate by voice, a “reverse 9-1-1” call to that number could present query 703 immediately after the call is answered, and then configure invite 706 based on the response.

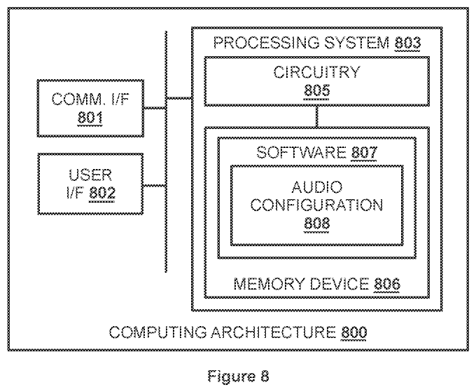

FIG. 8 illustrates computing architecture 800 for automatically specifying audio transmission characteristics between endpoints. Computing architecture 800 is an example computing architecture for call-type selection systems 101 and 401, although systems 101 and 401 may use alternative configurations. Other systems described above, such as the endpoints and TTY device 302, may also use computing architecture 800. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a computer readable storage medium, such as a disk drive, flash drive, data storage circuitry, or some other memory apparatus. In no examples would a computer readable storage medium of memory device 806, or any other computer readable storage medium herein, be considered a transitory form of signal transmission (often referred to as “signals per se”), such as a propagating electrical or electromagnetic signal or carrier wave. Operating software 807 comprises computer programs, firmware, or some other form of machine-readable processing instructions. Operating software 807 includes audio configuration module 808. Operating software 807 may further include an operating system, utilities, drivers, network interfaces, applications, or some other type of software. When executed by processing circuitry 805, operating software 807 directs computing architecture 800 to operate as described herein.

In particular, audio configuration module 808 directs computing architecture 800 to present a query to a user of a first endpoint about a type of call to be established with a second endpoint. The type of call is one of a plurality of call types that respectively correspond to different audio transmission characteristics. Audio configuration module 808 further directs computing architecture 800 to configure an audio transmission characteristic based on a response to the query and establish a call between the first endpoint and the second endpoint using the audio transmission characteristic.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
presenting a query to a user of a first endpoint about a type of call to be established with a second endpoint, wherein the type of call is one of a plurality of call types that respectively correspond to different audio transmission characteristics;
configuring an audio transmission characteristic based on a response to the query; and
establishing a call between the first endpoint and the second endpoint using the audio transmission characteristic.

2. The method of claim 1, comprising:
receiving the response in a first signaling type;
wherein the audio transmission characteristic corresponds to the first signaling type.

3. The method of claim 2, wherein the first signaling type includes a teletype (TTY) character and wherein the query directs the user to select any key on a TTY device at the first endpoint to transmit the TTY character in response to the query.

4. The method of claim 3, wherein the query directs the user to select any Dual-Tone Multi-Frequency (DTMF) key to transmit a second signaling type comprising a DTMF signal.

5. The method of claim 1, wherein the response indicates that the type of call is teletype (TTY) and wherein configuring the audio transmission characteristic comprises:
selecting a TTY-compatible transmission characteristic.

6. The method of claim 5, wherein the query asks the user whether the type of call is TTY or voice and wherein a voice-optimized transmission characteristic for a voice-type call is different than the TTY-compatible transmission characteristic.

7. The method of claim 1, wherein establishing the call comprises:
transmitting a session invite to the second endpoint that requests the call to have the audio transmission characteristic.

8. The method of claim 7, wherein the session invite is a Session Initiation Protocol (SIP) invite.

9. The method of claim 1, comprising:
exchanging user communications between the first endpoint and the second endpoint over the call.

10. The method of claim 1, comprising:
initiating establishment of the call to the first endpoint.

11. An apparatus comprising:
one or more computer readable storage media;
a processing system operatively coupled with the one or more computer readable storage media; and
program instructions stored on the one or more computer readable storage media that, when read and executed by the processing system, direct the apparatus to:
present a query to a user of a first endpoint about a type of call to be established with a second endpoint, wherein the type of call is one of a plurality of call types that respectively correspond to different audio transmission characteristics;
configure an audio transmission characteristic based on a response to the query; and
establish a call between the first endpoint and the second endpoint using the audio transmission characteristic.

12. The apparatus of claim 11, wherein the program instructions direct the processing system to:
receive the response in a first signaling type;
wherein the audio transmission characteristic corresponds to the first signaling type.

13. The apparatus of claim 12, wherein the first signaling type includes a teletype (TTY) character and wherein the query directs the user to select any key on a TTY device at the first endpoint to transmit the TTY character in response to the query.

14. The apparatus of claim 13, wherein the query directs the user to select any Dual-Tone Multi-Frequency (DTMF) key to transmit a second signaling type comprising a DTMF signal.

15. The apparatus of claim 11, wherein the response indicates that the type of call is teletype (TTY) and wherein to configure the audio transmission characteristic, the program instructions direct the apparatus to:
select a TTY-compatible transmission characteristic.

16. The apparatus of claim 15, wherein the query asks the user whether the type of call is TTY or voice and wherein a voice-optimized transmission characteristic for a voice-type call is different than the TTY-compatible transmission characteristic.

17. The apparatus of claim 11, wherein to establish the call, the program instructions direct the apparatus to:
transmit a session invite to the second endpoint that requests the call to have the audio transmission characteristic.

18. The apparatus of claim 17, wherein the session invite is a Session Initiation Protocol (SIP) invite.

19. The apparatus of claim 11, wherein the program instructions direct the processing system to:
exchange user communications between the first endpoint and the second endpoint over the call.

20. One or more computer readable storage media having program instructions stored thereon that, when read and executed by a processing system, direct the processing system to:
present a query to a user of a first endpoint about a type of call to be established with a second endpoint, wherein the type of call is one of a plurality of call types that respectively correspond to different audio transmission characteristics;
configure an audio transmission characteristic based on a response to the query; and
establish a call between the first endpoint and the second endpoint using the audio transmission characteristic.
